(19) United States
(12) Patent Application Publication
(10) Pub. No.: US 2014/0164762 A1
(43) Pub. Date: Jun. 12, 2014

(54) APPARATUS AND METHOD OF ONLINE AUTHENTICATION

(71) Applicants: HON HAI PRECISION INDUSTRY CO., LTD., New Taipei (TW); HONG FU JIN PRECISION INDUSTRY(ShenZhen) CO. LTD., Shenzhen (CN)

(72) Inventors: CHUNG-I LEE, New Taipei (TW); HAI-HONG LIN, Shenzhen (CN); GANG XIONG, Shenzhen (CN)

(73) Assignees: HON HAI PRECISION INDUSTRY CO., LTD., New Taipei (TW); HONG FU JIN PRECISION INDUSTRY(ShenZhen) CO., LTD., Shenzhen (CN)

(21) Appl. No.: 14/065,489

(22) Filed: Oct. 29, 2013

(30) Foreign Application Priority Data
Dec. 6, 2012 (CN) 2012105192032

(51) Int. Cl. H04L 29/06

(52) U.S. Cl. CPC H04L 63/0823; H04L 63/0838
USPC 713/155

(57) ABSTRACT

In a method of online authentication, digital certificates of a client device and an application server are verified when the application server receives a login request to a network application system installed in the application server from the client device. The application server authenticates an identification of the client device when both of the application server and the client device are valid. The client is permitted to log in the network application system of the application server when the identification of the client is valid, and is forbidden to log in to the network application system of the application server when the identification of the client is invalid.

### BACKGROUND

1. Technical Field

Embodiments of the present disclosure relate to network security technique, and more specifically relates to apparatus, system and method of authentication for online transactions.

2. Description of Related Art

With the Internet developing and growing everyday, online transactions have become an important way whereby people conduct some everyday business activities. However, online transactions typically require an Internet connection. For most transaction, users typically need to input a password or passwords through computers connected to the Internet during a transaction payment process. Passwords may be exposed to hacking, and if a user is hacked, the user may consequently suffer economic losses.

To increase the security of a transaction, dynamic password techniques, such as one-time password, (abbreviated as OTP) have been developed to improve protection of online transactions. The OTP is a password that is valid for only one login session or transaction.

However, conventional OTP technique may be still weak for some forms of hacker attacks, such as Trojan phishing. Trojan phishing refers to a method of simultaneously using a Trojan horse and phishing to accomplish the following: hijacking a user's transaction, creating the transaction on a third-party website, falsifying a display of the user's transaction, presenting the user with the transaction they wish to see, tricking the users into inputting their password, and causing the user to pay the bill to the hacker on the third-party website.

### BRIEF DESCRIPTION OF THE DRAWINGS

FIG. 1 is a block diagram of one embodiment of apparatus of online authentication.

FIG. 2 including FIG. 2A and FIG. 2B are block diagrams of a system of online authentication.

FIG. 3 including FIG. 3A and FIG. 3B are block diagrams of one embodiment of function modules of the system in FIG. 2.

FIG. 4 illustrates a flowchart of one embodiment of a method of online authentication.

FIG. 5 illustrates a flowchart of one embodiment of step S2 in FIG. 4.

FIG. 6 including FIG. 6A and FIG. 6B illustrate a flowchart of one embodiment of step S4 in FIG. 4.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

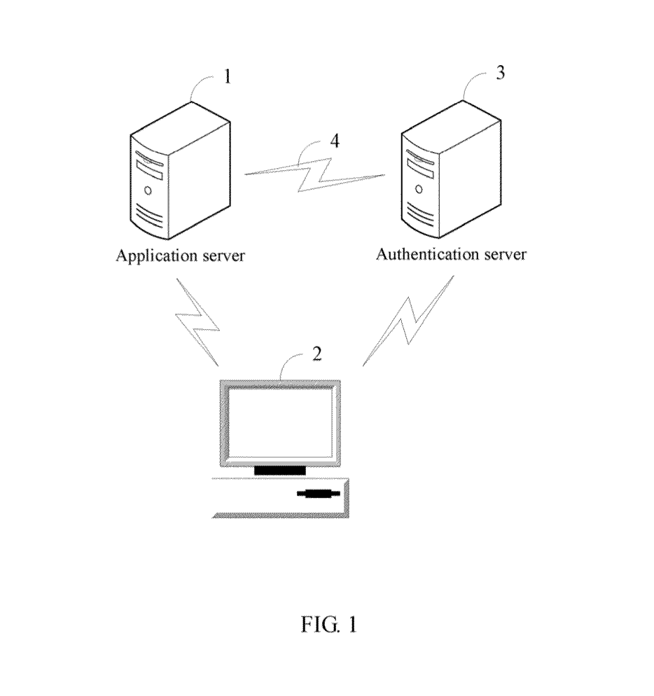

FIG. 1 is a block diagram of one embodiment of apparatus of online authentication. The apparatus includes electronic devices, such as an application server 1, a plurality of client devices 2 (one shown in FIG. 1), and an authentication server 3. The applicant server 1 is installed with network application systems, such as a web bank. Each of the client devices 2 is an electronic device including a computer, a smart phone, and a personal digital assistant (PDA), for example. The authentication server 3 is a certificate authority or certification authority (CA), which is an entity that issues digital certificates. The application server 1, the plurality of client devices 2, and the authentication server 3 network communicate with each other via a network 4, such as the Internet or an intranet.

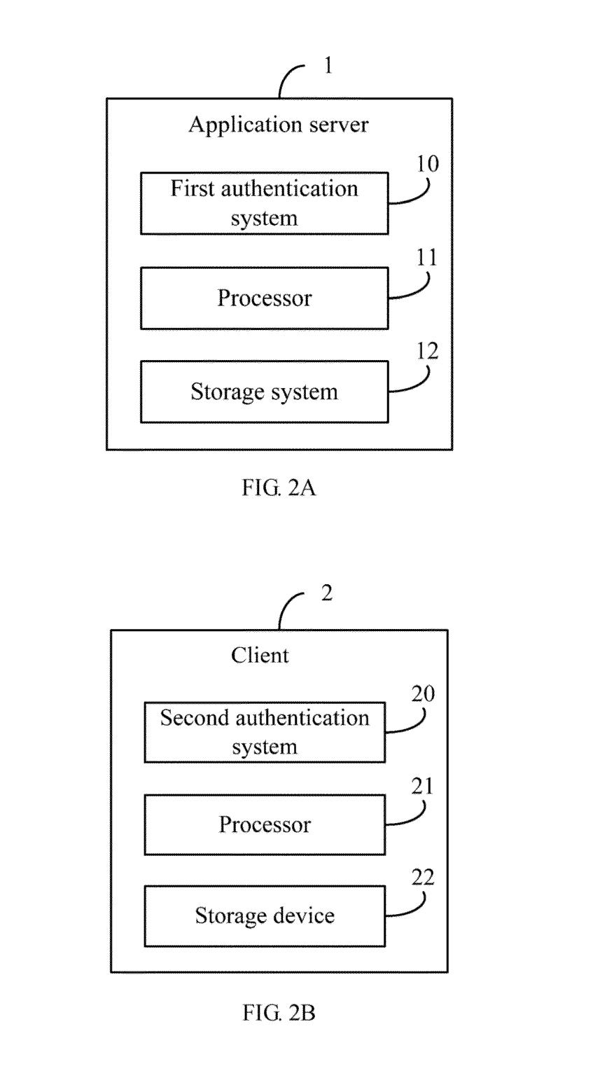

FIG. 2 including FIG. 2A and FIG. 2B are block diagrams of a system of online authentication. The system of online authentication includes a first authentication system 10 (shown in FIG. 2A), and a second authentication system 20 (shown in FIG. 2B). The first authentication system 10 is installed in the application server 1, and the second authentication system 20 is installed in each of the plurality of client devices 2.

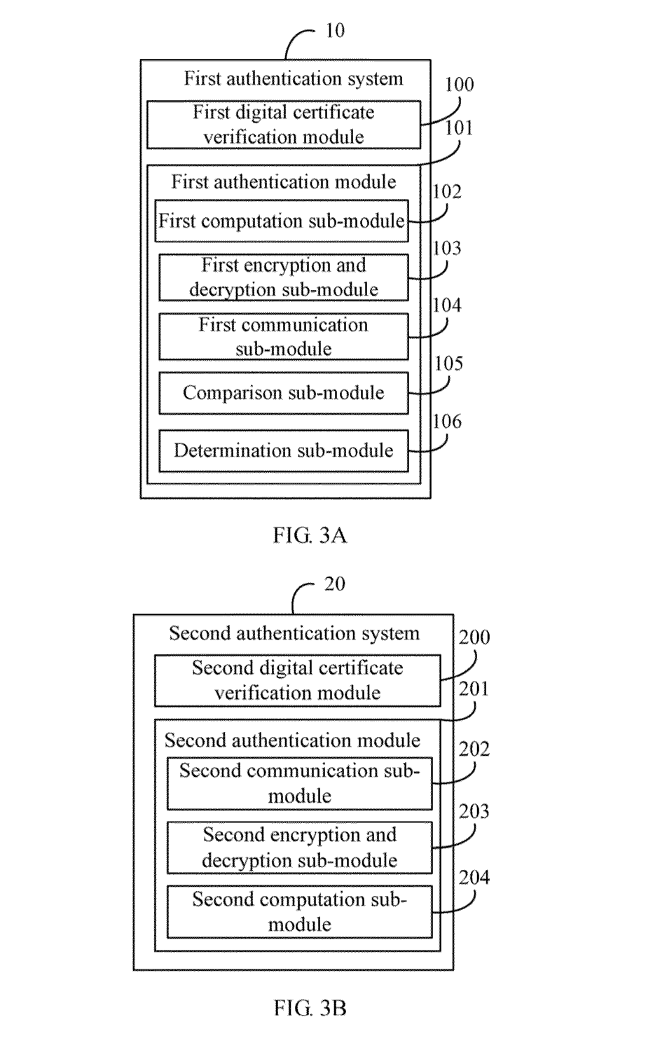

The first authentication system 10 and the second authentication system 20 respectively includes a plurality of function modules (see description of FIG. 3A and FIG. 3B below), which include computerized codes in the form of one or more programs. The function modules of the first authentication system 10 can be stored in a storage system 12 of the application server 1, and can be executed to realize some functions by a processor 11 of the application server 1. The function modules of the second authentication system 20 can be stored in a storage device 22 of the client device 2, and can be executed to realize some functions by a processor 21 of the client device 2.

The processor 11 of the application server 1 and the processor 12 of the client device 2 may be an application-specific integrated circuit (ASIC), or a field programmable gate array, (FPGA) for example.

The storage system 12 of the application server 1 and the storage device 22 of the client 2 may respectively include some type(s) of non-transitory computer-readable storage medium, such as a hard disk drive, a compact disc, a digital video disc, or a tape drive.

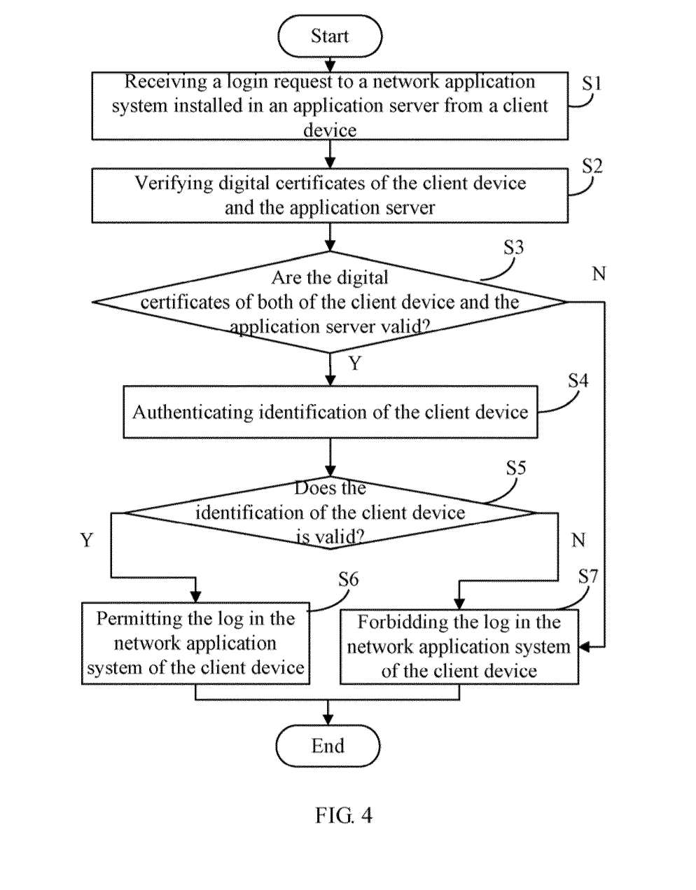

FIG. 3 including FIG. 3A and FIG. 3B are block diagrams of one embodiment of function modules of the system including the first authentication system 10 and the second authentication system 20 in FIG. 2. The first authentication system 10 includes a first digital certificate verification module 100 and a first authentication module 101. The first authentication module 101 includes a first computation sub-module 102, a first encryption and decryption sub-module 103, a first communication sub-module 104, a comparison sub-module 105, and a determination sub-module 106. The second authentication system 20 includes a second digital certificate verification module 200 and a second authentication module 201, where the second authentication module 201 includes a second communication sub-module 202, a second encryption and decryption sub-module 203, and a second computation sub-module 204. The function modules of the first authentication system 10 and the second authentication system 20 provide at least the functions needed to execute the steps illustrated in FIG. 4 below.

FIG. 4 illustrates a flowchart of one embodiment of a method of online authentication. The method is executed by at least one processor of an electronic device, for example, the processor 11 of the application server 1 and the processor 21 of the client devices 2. Depending on the embodiment, additional steps in FIG. 4 may be added, others removed, and the ordering of the steps may be changed.

In step S1, the first digital certificate verification module 100 of the application server 1 receives a login request to a network application system installed in the application server 1 from one of the client devices 2. In one embodiment, when a user inputs a username and a communication password to the network application system via the network 4 using the client device 2, a login request is generated and transmitted to the first digital certificate verification module 100.

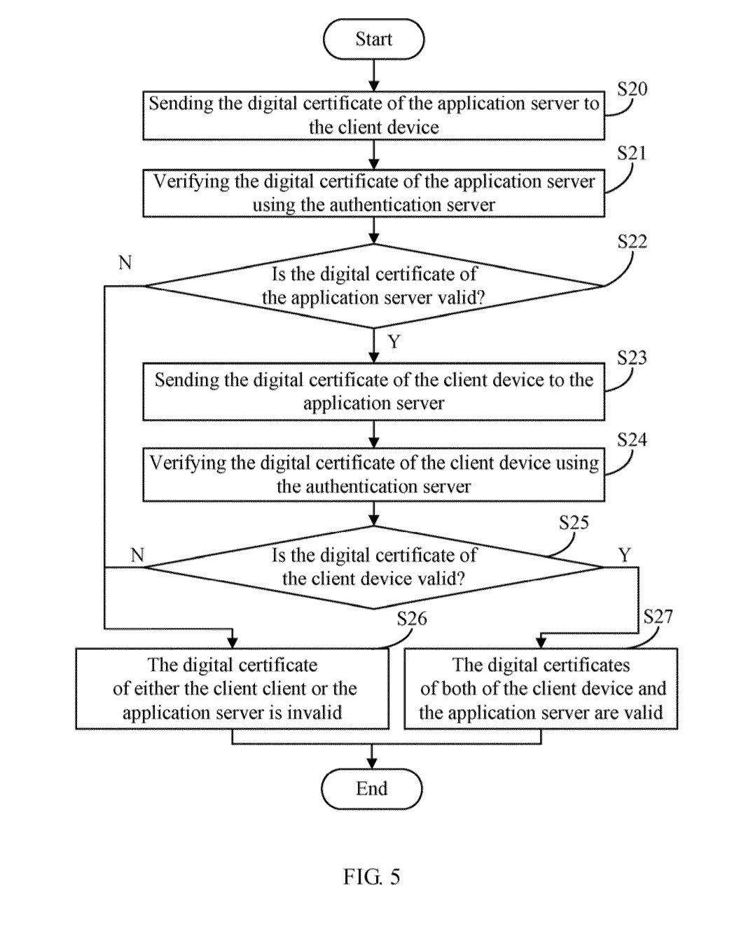

In step S2, the first digital certificate verification module 100 of the application server 1 verifies a digital certificate of the client device 2, and a second digital certificate verification module 200 of the client device 2 verifies a digital certificate of the application server 1. A detailed description of step S2 please refers to the description of FIG. 5 below.

In step S3, the first digital certificate verification module 100 of the application server 1 determines if the digital certificate of the client device 2 is valid, and the second digital certificate verification module 200 of the client device 2 determines if the digital certificate of the application server 1 is valid. Step S4 is implemented when the digital certificates of both of the application server 1 and the client device 2 are valid. Otherwise, step S7 is implemented when the digital certificate of any of the application server 1 and the client 2 is invalid.

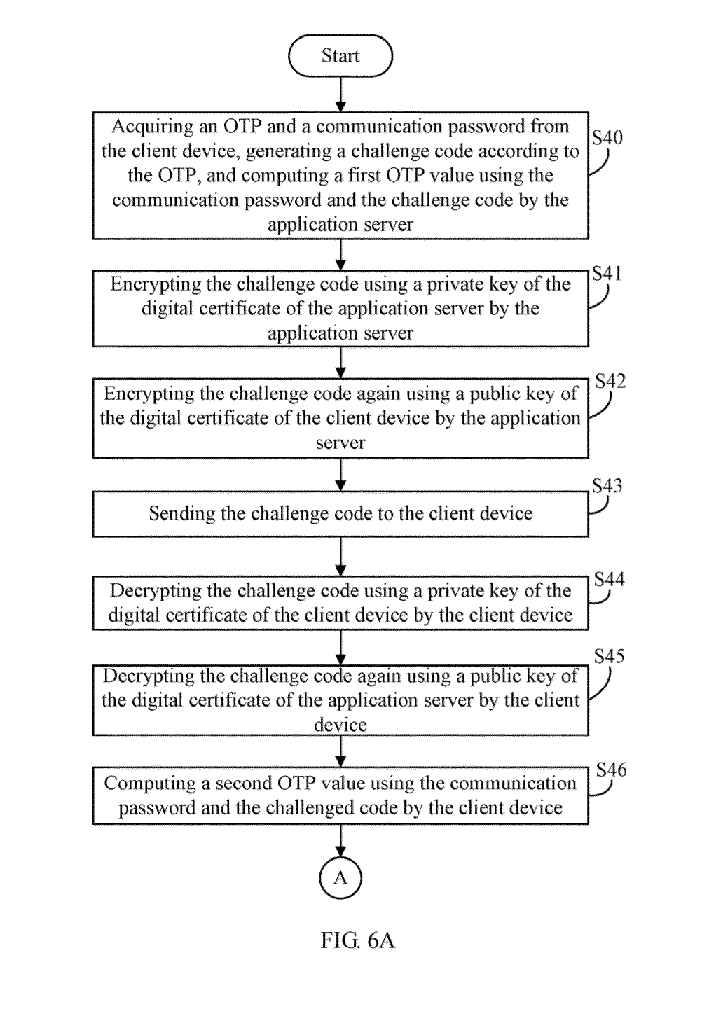

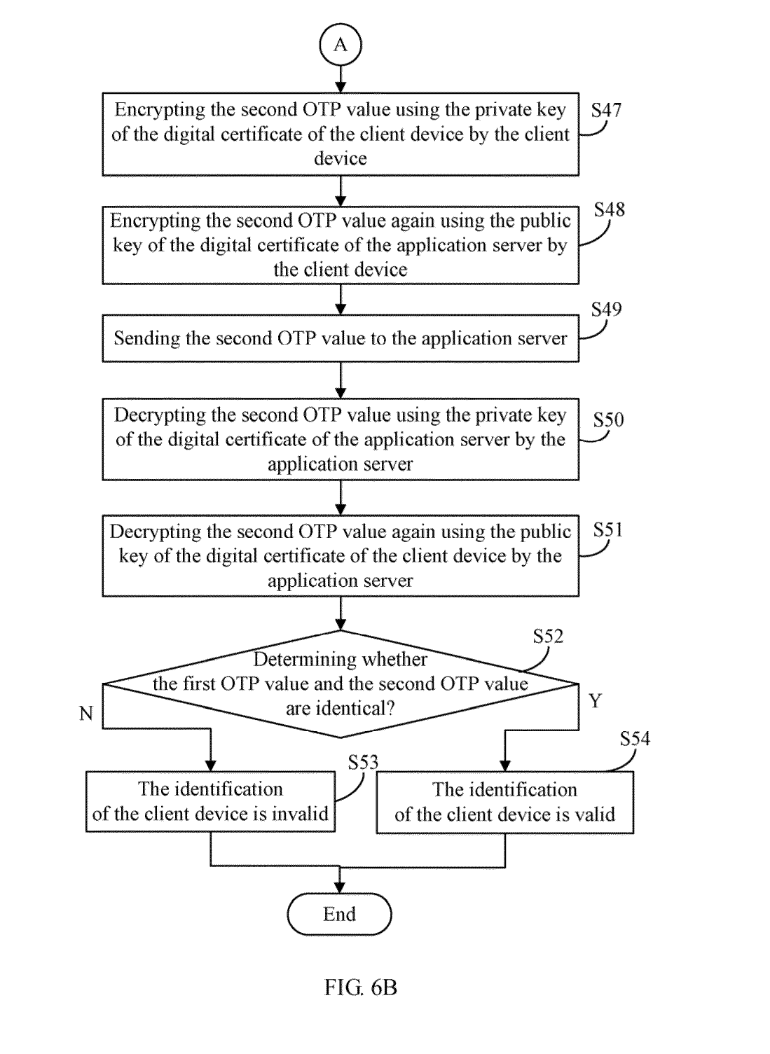

In step S4, the first authentication module 101 of the application server 1 and the second authentication module 201 of the client device 2 authenticate an identification of the client 2. A detailed description of the step S4 please refers to the description of FIG. 6 below.

In step S5, the first authentication module 101 of the application server 1 determines if the identification of the client 1 is valid. Step S6 is implemented when the identification of the client 1 is valid. Otherwise, step S7 is implemented the identification of the client 1 is invalid.

In step S6, the first authentication module 101 of the application server 1 permits the client device 2 to log in the network application system of the application server 1.

In step S7, the first authentication module 101 of the application server 1 forbids the client device 2 to log in the network application system of the application server 1.

FIG. 5 illustrates a flowchart of one embodiment of step S2 in FIG. 4. Depending on the embodiment, additional steps in FIG. 5 may be added, others removed, and the ordering of the steps may be changed.

In step S20, the first digital certificate verification module 100 of the application server 1 sends the digital certificate of the application server 1 to the client device 2. The digital certificate includes user information, a public key, a period of validity, and so on.

In step S21, the second digital certificate verification module 200 of the client device 2 receives the digital certificate of the application server 1 and verifies the digital certificate of the application server 1 using the authentication server 3.

In step S22, the second digital certificate verification module 200 of the client device 2 determines if the digital certificate of the application server 1 is valid according to a result returned from the authentication server 3. Step S23 is implemented when the digital certificate of the application server 1 is valid. Otherwise, step S26 is implemented when the digital certificate of the application server 1 is invalid.

In step S23, the second digital certificate verification module 200 of the client device 2 sends the digital certificate of the client device 2 to the application server 1. The digital certificate of the client device 2 also includes user information, a public key, a period of validity, and so on.

In step S24, the first digital certificate verification module 100 of the application server 1 verifies the digital certificate of the client device 2 using the authentication server 3.

In step S25, the first digital certificate verification module 100 of the application server 1 determines if the digital certificate of the client device 2 is valid according to a result returned from the authentication server 3. Step S26 is implemented when the digital certificate of the client device 2 is invalid. Otherwise, step S27 is implemented when the digital certificate of the client device 2 is valid.

In step S26, the digital certificate of either the client device 2 or the application server 1 is determined to be invalid.

In step S27, the digital certificate of both the client device 2 and the application server 1 are determined to be valid.

FIG. 6 including FIG. 6A and FIG. 6B illustrate a flowchart of one embodiment of step S4 in FIG. 4. Depending on the embodiment, additional steps in FIG. 6 may be added, others removed, and the ordering of the steps may be changed.

Referring to FIG. 6A, in step S40, the first computation sub-module 102 of the application server 1 acquires an one-time password (OTP) and a communication password from the client device 2, generates a challenge code according to the OTP, and computes a first OTP value using the communication password and the challenge code. The OTP can be generated, such as by the client device 2 using a security token, and the communication password is preset and inputted into the client device 2 by a user to login to the network application system installed in the application server 1. The challenge code can be generated using the OTP, a current time, and a dynamic value. The first OTP value can be computed using, for example, a MD5 message-digest algorithm.

In step S41, the first encryption and decryption sub-module 103 of the application server 1 encrypts the challenge code using a private key of the digital certificate of the application server 1.

In step S42, the first encryption and decryption sub-module 103 encrypts the challenge code again using a public key of the digital certificate of the client device 2.

In step S43, the first communication sub-module 104 sends the challenge code which have been encrypted twice to the client device 2.

In step S44, the second communication sub-module 202 of the client device 2 receives the challenge code, and the second encryption and decryption sub-module 203 of the client device 2 decrypts the challenge code using a private key of the digital certificate of the client device 2.

In step S45, the second encryption and decryption sub-module 203 of the client device 2 decrypts the challenge code again using a public key of the digital certificate of the application server 1.

In step S46, the second computation sub-module 204 of the client device 2 computes a second OTP value according to the communication password and the challenge code. The second OTP value is computed using the same algorithm with computing the first OTP value.

Referring to FIG. 6B now, in step S47, the second computation sub-module 204 of the client device 2 encrypts the second OTP value using the private key of the digital certificate of the client device 2.

In step S48, the second computation sub-module 204 of the client device 2 encrypts the second OTP value again using the public key of the digital certificate of the application server 1.

In step S49, the second communication sub-module 202 of the client device 2 sends the second OTP value which have been encrypted twice to the application server 1.

In step S50, the first encryption and decryption sub-module 103 of the application server 1 decrypts the second OTP value using the private key of the digital certificate of the application server 1.

In step S51, the first encryption and decryption sub-module 103 decrypts the second OTP value again using the public key of the digital certificate of the client device 2.

In step S52, the comparison sub-module 105 of the application server 1 determines whether the first OTP value is identical to the second OTP value. Step S54 is implemented when the first OTP value is identical to the second OTP value. Otherwise, step S53 is implemented when the first OTP value is not identical to the second OTP value.

In step S53, the determination sub-module 106 of the application determines that the identification of the client device 2 is invalid.

In step S54, the determination sub-module 106 of the application determines that the identification of the client device 2 is valid.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A method of online authentication, the method being executed by one or more processors of one or more electronic devices, the method comprising:
verifying digital certificates of a client device and an application server using an authentication server, when the application server receives a login request to a network application system installed in the application server from the client device;
authenticating an identification of the client by the application server when both of the application server and the client device are valid; and
permitting the client device to log in the network application system of the application server when the identification of the client device is valid, and forbidding the client device to log in the network application system of the application server when the identification of the client device is invalid.

2. The method according to claim 1, wherein the step of verifying digital certificates comprises:
the application server sending the digital certificate of the application server to the client device; and
the client device receiving the digital certificate of the application server and verifying the digital certificate of the application server using the authentication server.

3. The method according to claim 1, wherein the step of verifying digital certificates comprises:
the client device sending the digital certificate of the client device to the application server; and
the application server receiving the digital certificate of the client device and verifying the digital certificate of the client device using the authentication server.

4. The method according to claim 1, wherein the step of authenticating an identification of the client device comprises:
acquiring an one-time password (OTP) and a communication password from the client device, generating a challenge code according to the OTP, and computing a first OTP value using the communication password and the challenge code by the application server;
encrypting the challenge code using a private key of the digital certificate of the application server;
encrypting the challenge code again using a public key of the digital certificate of the client device;
sending the challenge code to the client device, and receiving a second OTP value from the client device, wherein the second OTP value is computed by the client device according to the challenge code and the communication password;
decrypting the second OTP value by the application server; and
determining whether the identification of the client is valid by determining whether the first OTP value is identical to the second OTP value.

5. The method according to claim 4, wherein the OTP is generated by the client device using a security token and the communication password is preset and inputted into the client device by a user for login to the network application system installed in the application server.

6. The method according to claim 4, wherein the second OTP value is computed by:
receiving the challenge code from the application server and decrypting the challenge code by the client device;
computing the second OTP value according to the communication password and the challenge code using an algorithm which is the same as an algorithm of computing the first OTP value; and
sending the second OTP value to the application server.

7. Apparatus that executes method of online authentication, the apparatus comprising:
one or more processors; and
one or more storage devices storing one or more programs which when executed by the processors, causes the apparatus to:
verify digital certificates of a client device and an application server when the application server receives a login request to a network application system installed in the application server from the client device;
authenticate an identification of the client device when both of the application server and the client device are valid; and
permit the client device to log in the network application system of the application server when the identification of the client device is valid, and forbid the client device to log in the network application system of the application server when the identification of the client is invalid.

8. The apparatus according to claim 7, wherein the digital certificates are verified using an authentication server.

9. The apparatus according to claim 7, wherein the apparatus comprises the application server and the client device.

10. The apparatus according to claim 9, wherein the application server:
acquires an one-time password (OTP) and a communication password from the client device, generate a challenge code according to the OTP, and computing a first OTP value using the communication password and the challenge code;
encrypts the challenge code using a private key of the digital certificate of the application server;
encrypts the challenge code again using a public key of the digital certificate of the client device;
sends the challenge code to the client device, and receive a second OTP value from the client device, wherein second OTP is computed by the client device according to the challenge code and the communication password;
decrypts the second OTP value by the application; and
determine if the identification of the client is valid by determining whether the first OTP value is identical to the second OTP value.

11. The apparatus according to claim 10, wherein the OTP is generated by the client device using a security token, and the communication password is preset and inputted into the client device by a user for login to the network application system installed in the application server.

12. The apparatus according to claim 7, wherein the client device:
receives the challenge code from the application server and decrypts the challenge code;
computes the second OTP value according to the communication password and the challenge code using an algorithm which is the same as an algorithm of computing the first OTP value; and
sends the second OTP value to the application server.

13. A non-transitory storage medium having stored thereon instructions that, when executed by one or more processor of one or more electronic devices, causes the processors to perform a method of online authentication, wherein the method comprises:
verifying digital certificates of a client device and an application server when the application server receives a login request to a network application system installed in the application server from the client device;
authenticating an identification of the client device when both of the application server and the client device are valid; and
permitting the client device to log in the network application system of the application server when the identification of the client device is valid, and forbidding the client device to log in the network application system of the application server when the identification of the client device is invalid.

14. The non-transitory storage medium according to claim 13, wherein the step of verifying digital certificates comprises:
the application server sending the digital certificate of the application server to the client device; and
the client device receiving the digital certificate of the application server and verifying the digital certificate of the application server using an authentication server.

15. The non-transitory storage medium according to claim 13, wherein the step of verifying digital certificates comprises:
the client device sending the digital certificate of the client device to the application server; and
the application server receiving the digital certificate of the client device and verifying the digital certificate of the client device using an authentication server.

16. The non-transitory storage medium according to claim 13, wherein the step of authenticating an identification of the client device comprises:
acquiring an one-time password (OTP) and a communication password from the client device, generating a challenge code according to the OTP, and computing a first OTP value using the communication password and the challenge code by the application server;
encrypting the challenge code using a private key of the digital certificate of the application server;
encrypting the challenge code again using a public key of the digital certificate of the client device;
sending the challenge code to the client device, and receiving a second OTP value from the client device, wherein the second OTP value is computed by the client device according to the challenge code and the communication password;
decrypting the second OTP value by the application server; and
determining if the identification of the client is valid by determining whether the first OTP value is identical to the second OTP value.

17. The non-transitory storage medium according to claim 16, wherein the OTP is generated by the client device using a security token, and the communication password is preset and inputted into the client device by a user for login to the network application system installed in the application server.

18. The non-transitory storage medium according to claim 16, wherein the second OTP value is computed by:
receiving the challenge code from the application server and decrypting the challenge code by the client device;
computing the second OTP value according to the communication password and the challenge code using an algorithm which is the same as an algorithm of computing the first OTP value; and
sending the second OTP value to the application server.
